(19) United States
(12) Patent Application Publication
(10) Pub. No.: US 2017/0206514 A9
(43) Pub. Date: Jul. 20, 2017

(54) METHOD OF PROVIDING APPLICATION AND APPARATUS FOR PERFORMING THE SAME

(71) Applicant: Electronics & Telecommunications Research Institute, (US)

(72) Inventors: Jong Hong JEON, Daejeon (KR); Sung Han KIM, Daejeon (KR); Seung Yun LEE, Daejeon (KR)

(73) Assignee: Electronics & Telecommunications Research Institute, Daejeon (KR)

(21) Appl. No.: 13/875,601

(22) Filed: May 2, 2013

(30) Foreign Application Priority Data
May 3, 2012 (KR) 10-2012-0046642
May 2, 2013 (KR) 10-2013-0049203

(51) Int. Cl. G06Q 20/12

(52) U.S. Cl. CPC G06Q 20/123

(57) ABSTRACT

A method of providing an application and an apparatus for performing the same are provided. The method of providing an application includes receiving a begging request message for requesting a specific begging target to purchase a specific application or a specific in-app function from a terminal of a begging requester, transmitting a begging request notification message to a terminal of the specific begging target when the specific begging target approves the begging request, and when the specific begging target purchases the specific application or the specific in-app function, approving download of the purchased specific application or registering a use right of the purchased specific in-app function.

### CLAIM FOR PRIORITY

This application claims priority to Korean Patent Application No. 10-2012-0046642 filed on May 3, 2012 and No. 10-2013-0049203 filed on May 2, 2013 in the Korean Intellectual Property Office KIPO), the entire contents of which are hereby incorporated by reference.

### BACKGROUND

1. Technical Field

Example embodiments of the present invention relate to technology for distributing applications online, and more specifically, to a method of providing an application and an apparatus for performing the same, which are capable of improving convenience of distribution of applications online.

2. Related Art

An application store or an app store (hereinafter referred to as an “app store”) is a term named by Apple In. in USA, and initially meant an online marketplace for application sales that enables application developers to register and sale applications operated in a mobile device or a specific operating system and users to search for and purchase desired applications.

An area of the app store has been extended to mobile devices as well as a variety of information processing terminals, such as televisions (TVs), tablet terminals, personal computers (PCs), or game consoles, and has been developed as an online market for distribution of a variety of electronic contents, including applications.

The app store enables an operator operating the app store to broker application developers and consumers, perform electronic payment required for this procedure, and divide sales revenue while operating an online marketplace system for electronic distribution of applications. In other words, the app store provides application consumers with technical means for enabling the consumers to conveniently purchase and install applications, and application developers with a variety of means for enabling the application developers to conveniently sell applications and manage a sale result.

Meanwhile, since there have already been online stores where applications for mobile devices are sold, the app stores may not be new ones for distribution of applications. However, existing online application distribution systems have been operated by mobile communication service providers in a closed manner. In other words, the existing application distribution system has primarily provided free or paid applications to only users who have signed up to be members of a specific mobile communication service provider.

With the advent of a variety of app stores led by terminal manufacturers such as Apple Inc. or platform developers such as Google since an app store of Apple Inc., not a mobile communication service provider, has been successfully operated in 2010, app stores are explosively growing.

Currently, 100 or more app stores are operated worldwide, and the number of times to download applications from the app stores is explosively growing. For example, in 2009, the number of times to download applications from the app stores has been totalized to be 2.5 billion. In 2013, the app stores increase more rapidly and the number of times to download applications is expected to be 21.6 billion.

Further, an amount of application sales through the app stores was $806.6 million in 2008 and reached $6107.40 million in 2010. The amount was $15805.30 million in 2012. The amount is expected to grow by 55 to 77 percentages each year.

Meanwhile, applications distributed through app stores may be roughly classified into paid applications and free applications depending on sale forms. The paid application is an application allowed to be downloaded only when a sale price of the application is paid, and typically, payment of the sale price of the application is performed at the time of sale of the application. The free application is an application allowed to be downloaded without separate price being paid for the application, and an application developer earns profits through advertisement displayed when the application is executed or basic functions of the application are provided for free and only specific functions are required to be paid through an in-app purchase (IAP) function.

According to a search result of HIS that is a market research firm, a scale of a payment market inside an app store based on in-app purchase (IAP) is expected to grow from $970 million in 2011 to $5600 million in 2015. Accordingly, an in-app purchase system in which an application is distributed for free and only primary functions of the application are required to be partially paid and used is expected to be more active.

However, in the conventional app store-based application distribution environment as described above, a way for the user to acquire the application is limited to a monolithic way for users capable of paying a price of the application. Accordingly, distribution and development of applications are limited.

For example, in the conventional app store-based application distribution environment, when a user provides a predetermined application as a gift to another user, the user providing the gift has to perform all procedures for application purchase and provision of the gift.

Accordingly, the user who provides the application as the gift may not exactly purchase an application desired by a user who will substantially use the application. When the user who provides the application as the gift is unfamiliar with the app store or the application, the user may suffer from a procedure of selecting the application to be provided as the gift and providing the gift through the app store.

Further, in the existing app store-based application distribution environment, there is no way for a user desiring to purchase an application to legally acquire the desired application when the user has no ability of purchasing the application, and there is no way for a user desiring to receive an expensive application as a gift to easily request and receive the desired application. Accordingly, targets who use the app store are limited to specific users having economic power.

### SUMMARY

Accordingly, example embodiments of the present invention are provided to substantially obviate one or more problems due to limitations and disadvantages of the related art.

Example embodiments of the present invention provide a method of providing an application, which enables a user to easily acquire a desired application or a specific function of the application.

Example embodiments of the present invention also provide an apparatus for performing the above method of providing an application.

In some example embodiments, a method of providing an application in an application providing apparatus includes: receiving a begging request message for requesting a specific begging target to purchase a specific application or a specific in-app function from a terminal of a begging requester; transmitting a begging request notification message to a terminal of the specific begging target when the specific begging target approves the begging request; and when the specific begging target purchases the specific application or the specific in-app function, approving download of the purchased specific application or registering a use right of the purchased specific in-app function.

Here, the transmitting of the begging request notification message to the terminal of the specific begging target may include: confirming whether the begging requester and the specific begging target have been registered and whether the specific begging target has approved a begging request; and when the specific begging target has approved a begging request, transmitting the begging request notification message to the terminal of the specific begging target.

Here, the transmitting of the begging request notification message to the terminal of the specific begging target may further include: transmitting a message indicating a begging request result to the terminal of the begging requester based on a result of confirming whether the specific begging target has approved the begging request.

Here, the transmitting of the begging request notification message to the terminal of the specific begging target may include: transmitting the begging request notification message to the terminal of the specific begging target as a push message.

Here, the approving of download of the purchased specific application or the registering of the use right of the purchased specific in-app function may include: receiving a message indicating begging approval or payment from the terminal of the specific begging target; performing a payment process for purchase of the specific application or the specific in-app function together with the terminal of the specific begging target; and transmitting a message indicating that the purchase of the specific application or the specific in-app function has been completed to the begging requester terminal when the payment for the specific application or the specific app function is completed.

Here, the transmitting of the message indicating that the purchase of the specific application or the specific in-app function has been completed to the begging requester terminal may include: transmitting information indicating a method of downloading the specific application or a method of registering the specific in-app function, the information being contained in the message indicating that the purchase of the specific application or the specific in-app function has been completed.

Here, the method may further include: providing, by the terminal of the begging requester, a user interface for creating an appreciation message, and delivering a received appreciation message to the terminal of the specific begging target when the appreciation message is received from the terminal of the begging requester.

Here, the method may further include: providing a user interface for a begging request for an application or an in-app function to the terminal of the begging requester.

Here, the method may further include: receiving a message instructing begging target recommendation from the terminal of the begging requester; selecting at least one begging target from a plurality of users based on a previously set criterion; and transmitting information on the at least one selected begging target as the begging target recommendation information to the terminal of the begging requester.

Here, the specific begging target may include a begging target selected by the begging requester from among the at least one begging target.

Here, the selecting of at least one begging target from a plurality of users based on a previously set criterion may include: selecting the at least one begging target based on begging success probability of each of the plurality of users.

In other example embodiments, a method of providing an application in an application providing apparatus includes: receiving a public begging request message for requesting a plurality of unspecified users to purchase a specific application from a terminal of a begging requester; registering a public begging request for the specific application; receiving a payment approval message for the specific application from any user terminal; performing a payment process for purchase of the specific application together with the user terminal; and transmitting a public begging success notification message for the specific application to the terminal of the begging requester when the payment process is completed.

Here, the method may further include: displaying public begging request status for each application.

Here, the method may further include: after transmitting a public begging success notification message for the specific application to the terminal of the begging requester, receiving a message for requesting download of the specific application from the terminal of the begging requester; and approving the download of the specific application.

Here, the method may further include: receiving an Installation completion message for the specific application from the terminal of the begging requester; and providing a user interface enabling the terminal of the begging requester to create an appreciation message, and delivering the received appreciation message to the user terminal when the appreciation message is received from the terminal of the begging requester.

In still other example embodiments, an application providing apparatus includes: a processing unit configured to receive a begging request message for requesting a begging target to purchase a specific application from a terminal of a begging requester, provide a begging request notification message to a terminal of the begging target, and approve download of a purchased application when the begging target has purchased the application; a communication unit configured to transmit the begging request notification message to the terminal of the begging target under control of the processing unit and provide the begging request message received from the terminal of the begging requester to the processing unit; and a storage unit configured to store information on the begging requester and the begging target, and application purchase history information.

Here, when a message instructing begging target recommendation is received from the terminal of the begging requester, the processing unit may select at least one begging target from a plurality of users based on a previously set criterion and then transmit information on the at least one selected begging target to the terminal of the begging requester via the communication unit.

Here, the processing unit may provide a user interface for a public begging request enabling a begging requester to request a plurality of unspecified users to purchase an application for each application, register the public begging request for the specific application when a public begging request message for a specific application is received from the terminal of the begging requester, and transmit a public begging success notification message for the specific application to the terminal of the begging requester via the communication unit when any user terminal purchases the specific application.

### EFFECTS OF THE INVENTION

According to the method of providing an application and the apparatus for performing the same as described above, a begging requester who requests purchase of a specific application or in-app function requests begging for the specific application or the function of the specific application to the begging target. When the begging target purchases a right of the application or the function by performing payment for the application or the function, the right of the purchased application or function is provided to the begging requester. Further, the begging requester can receive a desired application or function by recommending a user having the highest begging success probability for a specific application to the begging requester and requesting public begging to an unspecified number of users.

Accordingly, a user having no ability of purchasing the application can easily acquire the desired application through begging for the application or the function in the application.

Further, a user who has received a request for the application or the function in the application as a gift can also easily provide the application or the function to a user who has requested the gift, through only an approval and purchase procedure for the application or the function.

Further, according to the present invention, it is possible to easily connect a user desiring an application to be provided and a user purchasing the application through support of application begging, in-app function begging, begging target recommendation, and a public begging function as described above, and it is possible to contribute to high distribution of applications and an increase in the scale of economy of the applications.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an environment in which a method of providing an application according to an embodiment of the present invention is executed;

FIG. 2 is a block diagram illustrating a functional configuration of an application providing apparatus according to an embodiment of the present invention;

FIG. 3 is a block diagram illustrating a hardware configuration of the application providing apparatus according to an embodiment of the present invention;

FIG. 4 is a flow diagram illustrating a method of providing an application through application begging in an application providing method according to an embodiment of the present invention;

FIG. 5 is a flow diagram illustrating a method of providing an application through in-app function begging in the application providing method according to an embodiment of the present invention;

FIG. 6 is a flow diagram illustrating a method of providing an application through begging target recommendation in the application providing method according to an embodiment of the present invention;

FIG. 7 is a flow diagram illustrating a method of providing an application through public begging in the application providing method according to an embodiment of the present invention; and

FIG. 8 is a flow diagram illustrating a process of providing an application in an app store server in the application providing method according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, a term “user terminal” or “terminal” used in a description of an embodiment of the present invention is a concept including all of a variety of mobile devices such as a cell phone, a smart phone, a tablet PC, a pad type terminal, an MP3 player, a PMP (Portable Multimedia Player) or a game console, a variety of information processing devices such as a laptop computer or a PC, and consumer electronics such as a TV. Further, “user terminal” or “terminal” is not limited in a size, use, form or the like of the device, and is a concept including all devices capable of being connected to a network via a wired or wireless interface and downloading applications from an online application market (or an app store) accessed over the network.

Further, a term “begging” used in the description of an embodiment of the present invention may be used with a meaning of a predetermined user requesting a specific user or a number of other unselected users to purchase a desired application or a specific function in the application (or a right for the specific function) or to provide the application or the function as a gift.

Further, in the description of an embodiment of the present invention, “application” and “app” have the same meaning and may be used together. For example, “application” may be referred to as “App” and “a function in an application” may be referred to as “in-app function.”

A method of providing an application according to an embodiment of the present invention includes an application begging method in which a begging requester requests a begging target to purchase an application and the purchased application is provided as a gift to the begging requester when the begging target approves purchase of the application and performs payment to purchase the application, an in-app function begging method in which a begging requester requests in-app purchase for an in-app function and a begging target purchases the in-app function (or a function use right) and provides the purchased in-app function (or function use right) to the begging requester, a begging target recommendation method in which a begging target having high begging success probability is automatically recommended and a begging requester requests begging for an application or an in-app function to the recommended begging target, and a public begging method in which a large number of unspecified users are targets.

An application providing apparatus according to an embodiment of the present invention performs a process of supporting the begging methods described above.

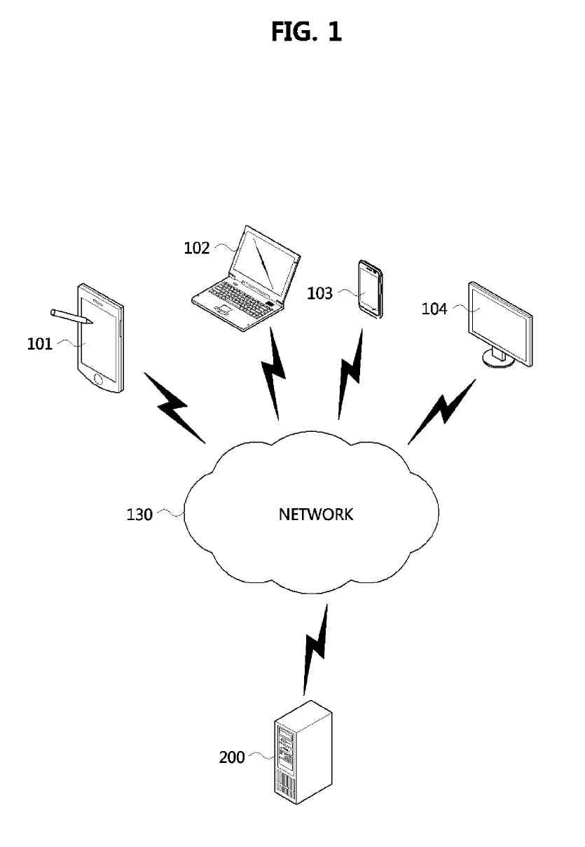

FIG. 1 is a conceptual diagram illustrating an environment in which a method of providing an application according to an embodiment of the present invention is executed.

Referring to FIG. 1, the method of providing an application according to an embodiment of the present invention may be executed in an environment in which a variety of user terminals such as a tablet personal computer (PC) (or a pad-type terminal) 101, a PC 102, a smartphone 103, and a television (TV) 104 having a network connection function can be connected to an application providing apparatus 200 over a network 130.

The application providing apparatus 200 may be implemented in a variety of forms, but in the following description, the application providing apparatus 200 is assumed to be an app store server, for convenience of description.

The variety of user terminals 101 to 104 illustrated in FIG. 1 may be used as terminals of begging requesters who request begging for applications or in-app functions or may be used as terminals of begging targets who are begging request targets for the application or the in-app function selected by the begging requester.

A browser for access to the app store server 200 or a client application for access to an app store may be installed in each of the user terminals 101 to 104. The begging requester may access the app store server 200 connected to the network 130 using the installed browser or app store access client application and request begging.

When the user terminals 101 to 104 are used as terminals of application or in-app function begging requesters, each user terminal accesses the app store server 200 according to a manipulation of the begging requester, and provides the app store server 200 with selection information for a specific application or a specific in-app function selected by the begging requester and begging target information for a begging request. The user terminal downloads and installs the application or the in-app function from the app store server 200 or registers a use right of the in-app function when the begging target approves the begging and completes payment for the application or the in-app function as the begging target.

Or, when the user terminals 101 to 104 are used as the terminals of begging targets who receive begging of a specific application or in-app function, each user terminal receives a begging request notification message for the specific application or in-app function from the app store server 200, displays the begging request notification message, transmits a begging message indicating approval of the begging request to the app store server 200 according to a manipulation of the begging target, and then performs a procedure related to purchase of the application or the in-app function. Here, when the begging target does not approve the begging request, the user terminal may transmit a begging refusal message to the app store server 200 or may not transmit any message to the app store server 200 such that the app store server 200 can tacitly recognize that the begging target has refused the begging request.

The network 130 may be configured as a wireless network or may be configured as a wired network. Alternatively, the network 130 may be configured to have a structure in which wired and wireless networks such as the Internet, a mobile communication network, and a wireless local area network are present in a mixed form or in conjunction with one another.

The app store server 200 is an apparatus that performs the application providing method according to an embodiment of the present invention, and processes an app store function of enabling a variety of user terminals to access the app store and select and purchase applications.

In particular, the app store server 200 processes an application begging function and an in-app function begging function for a request and provision of the application and the in-app function between the begging requester whose requests a gift of the function and the in-app function and the begging target that is a begging request target.

Further, the app store server 200 processes a begging target recommendation function of recommending a begging target having highest begging success probability among begging targets, and a public begging function of enabling a begging requester desiring an application to be acquired to request application begging to a number of unspecified users.

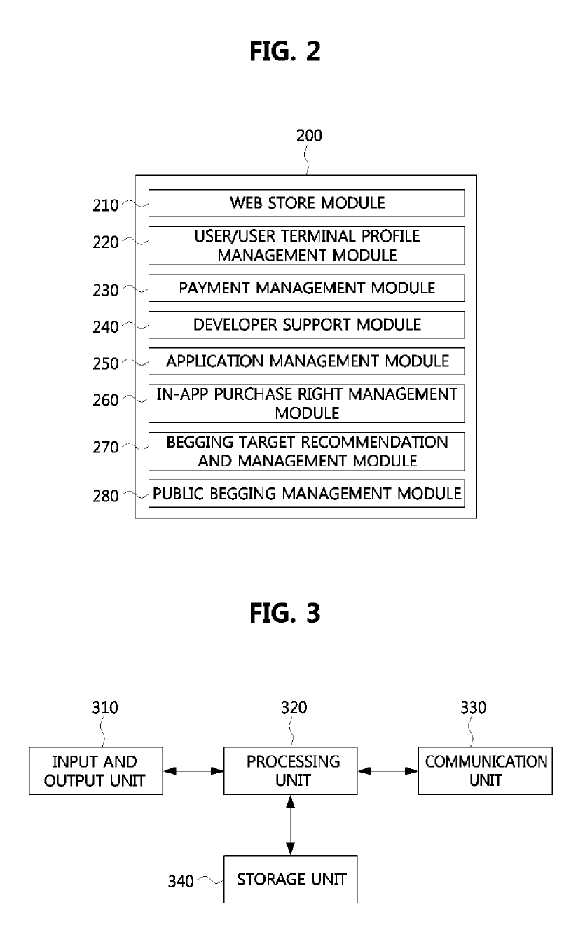

FIG. 2 is a block diagram illustrating a functional configuration of the application providing apparatus according to an embodiment of the present invention.

Referring to FIG. 2, the app store server 200 may include a web store module 210, a user/user terminal profile management module 220, a payment management module 230, a developer support module 240, an application management module 250, an in-app purchase right management module 260, a begging target recommendation and management module 270, and a public begging management module 280.

The web store module 210 provides details for each of applications registered in the app store server. Further, the web store module 210 provides a user interface for a begging request for an application or an in-app function. Here, the web store module 210 may provide a user interface, such as a button for a begging request or a public begging request for each application or in-app function, or may provide a menu for enabling the begging requester to select a begging target.

The user/user terminal profile management module 220 is a module that manages profiles of the user and the user terminal, and may collectively manage identification information of the users and/or the user terminal, personal information, user-specific application purchase history information, payment information for purchase, and the like.

The payment management module 230 performs a process for payment when the user purchases the application or the in-app function.

The developer support module 240 performs a process for supporting an application developer. For example, the developer support module 240 may support a process of enabling the application developer to register an application in the app store and sell the application or may support operation and operational management related to sale of applications.

The application management module 250 performs a process for management such as registration, deletion, and update of applications.

The in-app purchase right management module 260 performs a process of supporting an in-app function begging function. For example, the in-app purchase right management module may provide a user interface for a begging request for applications that support the in-app purchase function, and may perform a process of giving a right for the in-app function or downloading the in-app function upon purchase of the in-app function.

The begging target recommendation and management module 270 performs a function of recommending at least one begging target for a specific application or an app function based on information such as a relationship between users, intimacy, application purchase history, and begging approval rates of begging targets.

The public begging management module 280 supports a public begging function of enabling a begging requester to publicly request begging to a number of unspecified users.

Each of the modules 210 to 280 illustrated in FIG. 2 may independently perform its functions or may perform the function in conjunction with the other modules.

For example, the user/user terminal profile management module 220 may receive begging request information or begging target information from the web store module 210, update the begging request or begging target profile information, and update purchase history information of the begging target when the begging target purchases the application or the in-app function as the begging target.

Further, the begging target recommendation and management module 270 may select a begging target to be recommended using information such as users' application purchase history, the number of begging requests, the number of receptions of begging requests, and application purchase history information from the user/user terminal profile management module 220 and provide the selected begging target to be recommended to the web store module 210, so that the web store module 210 displays information on the begging target to be recommended when displaying details of the application.

Further, the function performed by each of the above-described modules 210 to 280 may be implemented in the form of program instructions that can be read and processed by a processor, and the program instructions for performing the function of each module may be stored in a nonvolatile storage medium.

FIG. 3 is a block diagram illustrating a hardware configuration of the application providing apparatus according to an embodiment of the present invention, and illustrates a hardware configuration of the app store server 200 shown in FIG. 2.

Referring to FIG. 3, the application providing apparatus 300 according to an embodiment of the present invention may include an input and output unit 310, a processing unit 320, a communication unit 330, and a storage unit 340.

In the input and output unit 310, an input unit and an output unit may be configured in an independent form or the input unit and the output unit may be configured as a single entity. When the input unit and the output unit are configured in an independent form, the input unit may include a device such as a keyboard, a mouse, or a digitizer, and the output unit may include a display device. The input and output unit 310 may be configured as a single device, such as a touch screen.

The input and output unit 310 displays a user interface under control of the processing unit 320, provides the processing unit 320 with a key input signal corresponding to an input or manipulation of a manager who manages the application providing apparatus 300, and displays a processing result provided from the processing unit 320.

The processing unit 320 may include at least one processor, and processes the app store function, the user/user terminal profile management function, the payment management function, the developer support function, the application management function, the in-app purchase right management function, the begging target recommendation and management function, and the public begging management function illustrated in and described with reference to FIG. 2, and performs control for processing the above functions.

The communication unit 330 may include a wired and/or wireless network interface. The communication unit 330 performs a process of enabling a plurality of user terminals to access the application providing apparatus 300 over the network, and performs data communication with at least one user terminal under control of the processing unit 320.

The storage unit 340 may include a large capacity of nonvolatile storage means, and stores information for a plurality of users and user terminals, application purchase history information, and the like. In other words, the storage unit 340 may store information required in performing the application providing method according to an embodiment of the present invention or result information derived by performing the application providing method. Methods performed by the modules illustrated in FIG. 2 may be recorded in the storage unit 340. Here, the storage unit 340 may be included inside the application providing apparatus 300 or may be configured as a separate independent device and connected over the network.

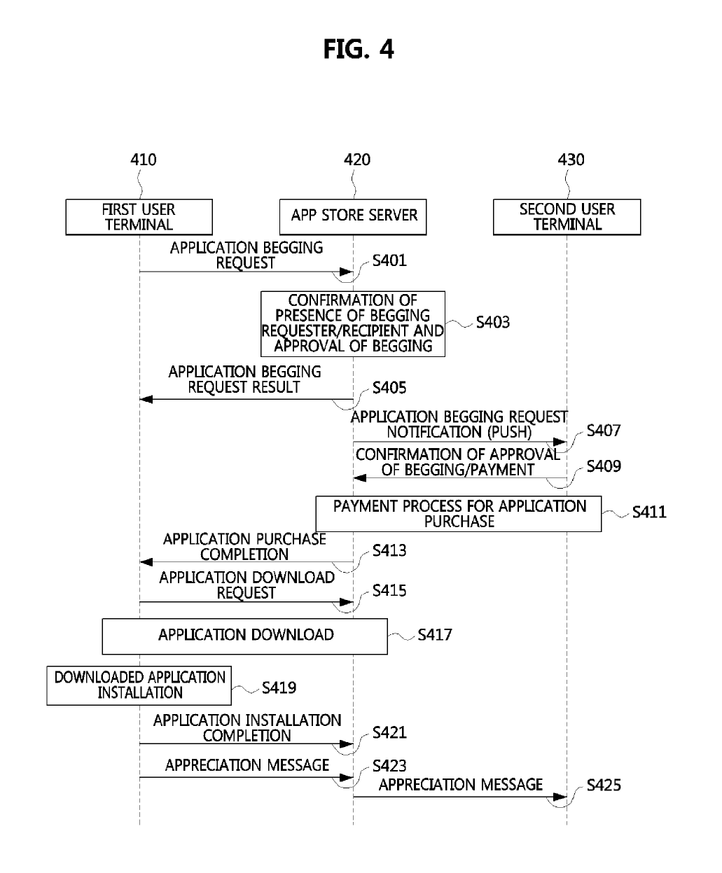

FIG. 4 is a flow diagram illustrating a method of providing an application through begging in the application providing method according to an embodiment of the present invention.

In FIG. 4, a first user terminal 410 refers to a user terminal of a begging requester who requests begging of a specific application, and a second user terminal 430 refers to a user terminal of a begging target who receives a begging request. A type of terminal is not limited to a specific type.

Referred to FIG. 4, the first user terminal 410 accesses an app store server 420 according to a manipulation of the begging requester. Then, when the begging requester selects a specific application, requests begging for the selected application, and selects a second user as a begging target, the first user terminal 410 transmits a begging request message for the application selected by the begging requester to the app store server 420 (S401). Here, information on the application selected by the begging requester and begging target information may be contained in the begging request message.

When the app store server 420 receives the begging request message from the first user terminal 410, the app store server 420 confirms whether there are the begging requester and the begging target and confirms whether the begging target approves the begging request (S403). Here, the app store server 420 may confirm whether there are the begging requester and the begging target by determining whether both the begging requester and the begging target are registered users.

Further, each user terminal or user registered in the app store server 420 may set whether to approve the begging request. Here, if the begging target sets to approve the begging request, the app store server 420 may transmit a begging request notification message to the user terminal of the begging target when there is a begging request from the begging requester. If the begging target sets not to approve the begging request, the app store server 420 may not transmit the begging request notification message to the user terminal of the begging target.

The app store server 420 then transmits a message indicating a begging request result according to a determination result in step S403 to the first user terminal 410 (S405). Here, when the begging target is a registered user and approves the begging request, the app store server 420 may transmit to the first user terminal 410 a message indicating that the begging request is allowed to be transmitted. When the begging target is a registered user but does not approve the begging request or when the begging target is not a registered user, the app store server 420 may transmit to the first user terminal 410 a message indicating that the begging request is not allowed to be transmitted.

Further, when the begging request is possible as a result of the determination in step S403, the app store server 420 transmits a begging request notification message containing the information for the application selected by the begging requester to the second user terminal 430 (S407). Here, information on the begging requester may be contained in the begging request notification message, which may be transmitted in the form of a push message according to a predetermined format.

When the second user terminal 430 receives the push message from the app store server 420, the second user terminal 430 displays the received push message. Here, in the displayed push message, information on the begging requester having requested begging and the begging target application may be displayed. Purchase price information for the application as the begging target, and a message or a user interface for inquiring whether the begging request and payment is approved may be additionally displayed.

The second user terminal 430 then transmits a message indicating whether the begging is approved and/or whether the payment is approved to the app store server 420 in response to a manipulation of the begging target (S409).

Here, when the begging target who is the user of the second user terminal 430 approves the requested begging and also approves the payment for the application, the second user terminal 430 and the app store server 420 perform a payment process corresponding to the purchase of the begging target application (S411).

When the payment for the begging target application is completed, the app store server 420 transmits a message indicating that the purchase for the begging target application is completed to the first user terminal 410 (S413), and the first user terminal 410 displays an application purchase completion message corresponding to the message provided from the app store server 420. Here, the purchase completion message for the begging target application may be also transmitted in the form of a push message and displayed on the user terminal 410, and may contain a method of downloading the application for which the purchase has been completed.

The first user terminal 410 then makes a request for download of the begging target application to the app store server 420 in response to a manipulation of the begging requester (S415) and downloads the application from the app store server 420 (S417). Here, the first user terminal 410 may make a request for download of the begging target application to the app store server 420 and download the application from the app store server 420 using a browser or an app store client application.

When the download of the application is completed, the first user terminal installs the downloaded application (S419).

The first user terminal 410 then transmits a message indicating that the installation of the application has been completed to the app store server 420 (S421).

Further, the first user terminal 410 automatically creates an appreciation message for the application purchase or application gift of the begging target or provides a user interface for creation of the appreciation message. When the appreciation message is created, the first user terminal 410 transmits the appreciation message to the app store server 420 (S423). The app store server 420 transmits the appreciation message received from the first user terminal 410 to the second user terminal 430 (S425).

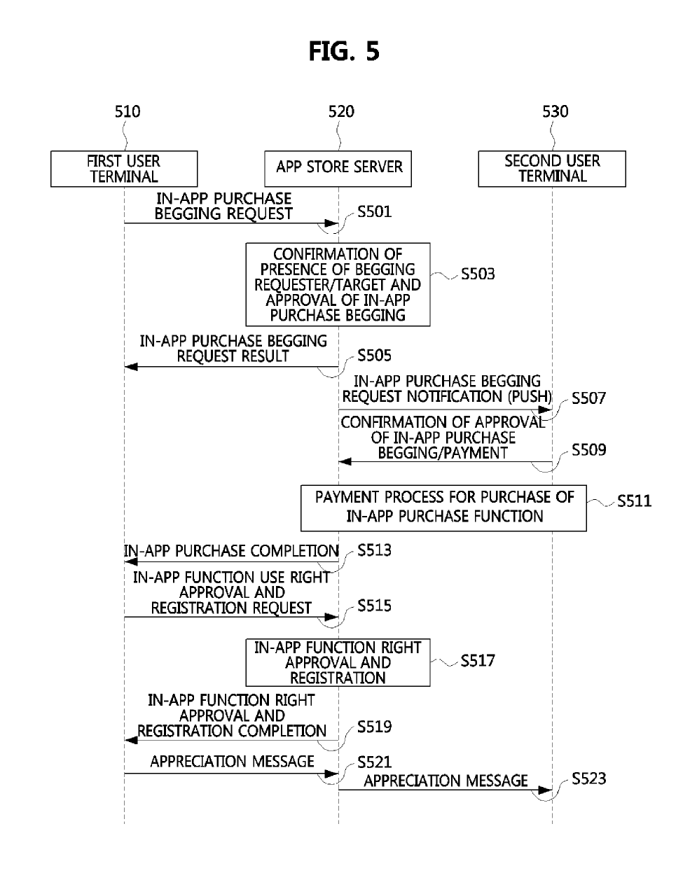

FIG. 5 is a flow diagram illustrating a method of providing an application through in-app function begging in the application providing method according to an embodiment of the present invention, and illustrates a procedure in which, during execution of a specific application installed on a first user terminal 510, in-app function begging for a specific function requiring a use right is requested and the use right for the specific function is acquired through in-app purchase.

In FIG. 5, the first user terminal 510 refers to a user terminal of a begging requester who requests in-app purchase begging for a specific function among functions of a specific application, and a second user terminal 530 refers to a user terminal of a begging target who receives the in-app purchase begging request. A type of user terminal is not limited to a specific type.

Referring to FIG. 5, when, during execution of a specific application in the first user terminal 510, the begging requester selects a specific function requiring a use right, requests in-app purchase begging for the selected specific function of the application, and selects a second user as a begging target according to a manipulation of the begging requester, the first user terminal 510 transmits a request message for in-app purchase begging selected by the begging requester to an app store server 520 (S501). Here, information on the in-app function selected by the begging requester and begging target information may be contained in the in-app purchase begging request message.

When the app store server 520 receives the in-app purchase begging request message from the first user terminal 510, the app store server 520 confirms whether there are the in-app purchase begging requester and the begging target, and determines whether the begging target approves the in-app purchase begging request (S503). Here, the app store server 520 may confirm whether there are the begging requester and the begging target by determining whether both the in-app purchase begging requester and the begging target are registered users. Further, each user terminal or user registered in the app store server 520 may set whether to approve the in-app purchase begging request. Here, when the begging target sets to approve the begging request for in-app purchase, an in-app purchase begging request notification message may be transmitted to the user terminal of the begging target, and when the begging target sets not to approve the begging request for in-app purchase, the in-app purchase begging request notification message may not be transmitted to the user terminal of the begging target.

The app store server 520 then transmits a message indicating the in-app purchase begging request result according to the determination result in the step S503 to the first user terminal 510 (S505). Here, when the begging target is a registered user and approves the in-app purchase begging request, the app store server 520 may transmit a message indicating that the in-app purchase begging request is possible to the first user terminal 510. When the begging target is a registered user and does not approve the in-app purchase begging request or when the begging target is not a registered user, the app store server 520 may transmit a message indicating that the in-app purchase begging request is not possible to the first user terminal 510.

Further, when the in-app purchase begging request is possible as a result of the determination in step S503, the app store server 520 transmits an in-app purchase begging request notification message containing information on the function in the application selected by the begging requester to the second user terminal 530 (S507). Here, the in-app purchase begging request notification message may contain information on the first user and may be transmitted in the form of a push message according to a predetermined format.

When the second user terminal 530 receives the push message from the app store server 520, the second user terminal 530 displays the received push message. Here, in the displayed push message, information on the begging requester having requested in-app purchase begging and information for the specific function of the in-app purchase begging target application may be displayed. Purchase price information for the application as the in-app purchase begging target, and a message or a user interface for inquiring whether the in-app purchase begging request and payment is approved may be additionally displayed.

The second user terminal 530 then transmits a message indicating whether in-app purchase begging is approved and/or whether the payment is approved to the app store server 520 in response to a manipulation of the begging target (S509).

Here, when the begging target who is the user of the second user terminal 530 approves the in-app purchase begging and also approves the payment for the application function, the second user terminal 530 and the app store server 520 perform a payment process for the in-app purchase begging target function (S511). Here, the purchase of the in-app function may mean acquisition of a right to use the in-app function or may mean separate purchase of a file for performing the in-app function.

When the payment for the in-app purchase begging target application function is completed, the app store server 520 transmits a message indicating that the purchase of the in-app purchase begging target application function has been completed to the first user terminal 510 (S513). The first user terminal 510 displays an in-app function purchase completion message in response to the message provided from the app store server 520. The in-app purchase begging target in-app function purchase completion message may also be transmitted in the form of a push message and displayed, and may include a method of registering the in-app function for which the purchase has been completed and a method of downloading a file for supporting the in-app function.

Then, the first user terminal 510 executes the in-app purchase begging target application in response to a manipulation of the in-app purchase begging requester and then transmits a message for requesting approval of a use right for the function for which the in-app purchase begging has been requested and/or registration of the right to the app store server 520 (S515).

In response to the message for requesting approval of a right for the in-app purchase target function and/or registration of the right, which is transmitted from the first user terminal 510, the app store server 520 performs a process for approval of the use right for the in-app purchase target function and/or registration of the right (S517). When the process is completed, the app store server 520 transmits a message indicating that the approval of the use right for the in-app purchase target function and/or registration of the right has been completed to the first user terminal 510 (S519).

Here, when download of a file is necessary for execution of the in-app purchase target function, the app store server 520 may transmit a message instructing download of the file of the function to the first user terminal 510 after the approval and/or registration of the right for the in-app purchase target function is completed. In response to the message, the first user terminal 510 may download and install the file for execution of the in-app purchase target function from the app store server 520.

When the message indicating approval and/or registration of the right of the in-app purchase target function has been completed is received from the app store server 520, the first user terminal 510 automatically creates an appreciation message for the application function purchase or an application function gift of the in-app purchase begging target or provides a user interface for creation of the appreciation message, and transmits the appreciation message to the app store server 520 when the appreciation message is created (S521). The app store server 520 delivers the appreciation message received from the first user terminal 510 to the second user terminal 530 (S523).

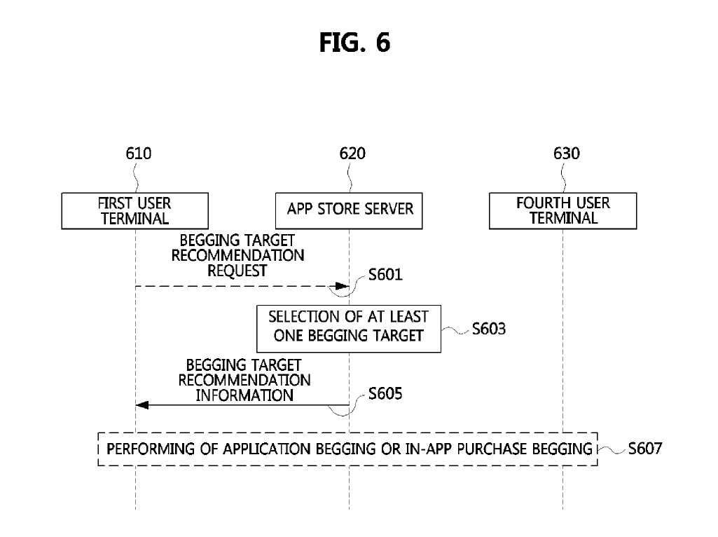

FIG. 6 is a flow diagram illustrating a method of providing an application through begging target recommendation in the application providing method according to an embodiment of the present invention, and illustrates a process in which an app store server 620 recommends at least one begging target among a plurality of users, and a begging requester selects a specific begging target from among the at least one begging target that has been recommended and requests application begging or requests in-app purchase begging.

Referring to FIG. 6, first, the app store server 620 may provide, in a user interface of the app store, a user interface such as a menu for supporting the begging target recommendation.

When the begging requester accesses the app store through a browser or an app store client application executed on the first user terminal 610 and then selects begging target recommendation for a specific application or selects begging target recommendation for a specific in-app function, the first user terminal 610 may transmit a message indicating a request for begging target recommendation to the app store server 620 (S601). Alternatively, when the begging requester requests the recommendation of the begging target through a begging target recommendation menu regardless of the specific application or in-app function, the first user terminal 610 may transmit the message indicating the request for begging target recommendation to the app store server 620. Here, the begging target recommendation request message may contain information on the begging requester who requests the begging, and information for the begging target application or the in-app purchase begging target function.

When the app store server 620 receives the begging target recommendation request message from the first user terminal 610, the app store server 620 selects at least one begging target among a plurality of users (or a plurality of begging target candidates) based on a previously set criterion (S603). Here, the begging target recommendation may be performed by the begging target recommendation and management module 270 of the app store server 620. The begging target recommendation and management module 270 may acquire information such as the user information and the application purchase history managed by the user/user terminal profile management module 220, analyze the acquired information, and select at least one begging target based on a previously set criterion.

For example, the begging target recommendation and management module 270 may recommend the begging target based on a relationship between the begging requester who has requested the begging and the plurality of users or may recommend the begging target based on a ratio of the number of receptions of the begging request and the number of approvals of the begging request by each user (i.e., a begging request success rate). Alternatively, the begging target recommendation and management module 270 may recommend the begging target according to a price of the application or the in-app purchase target function for which the begging has been requested by the begging requester, or may calculate a begging success probability in consideration of both of the above-described criteria and any other criteria and recommend a previously set number of the begging targets in order of higher probability.

The app store server 620 selects at least one begging target as described above, and then transmits recommendation information for the at least one selected begging target to the first user terminal 610 (S605).

The first user terminal 610 performs an application begging or in-app purchase begging process by displaying the recommendation information for the at least one begging target received from the app store server 620 so that the begging requester can select the begging target for the application or the in-app purchase target function, and transmitting a message for requesting application begging or in-app purchase begging to the app store server 620 when the begging requester selects a predetermined begging target (S607).

Here, since a process in which the begging requester requests the application begging is the same as that illustrated in and described with reference to FIG. 4, a detailed description thereof is omitted in order to avoid unnecessary duplication. Further, since a process in which the begging requester requests the in-app purchase begging is the same as that illustrated in and described with reference to FIG. 5, a detailed description thereof is omitted.

The example in which the first user selects a fourth user terminal 630 from among at least one begging target recommended by the app store server 620, and processes application begging or in-app purchase function begging with the fourth user terminal 630 is shown in FIG. 6.

Further, the example in which the first user terminal 610 makes a request for begging target recommendation for the specific application or in-app function, and in response thereto, the app store server 620 recommends at least one begging target is shown in FIG. 6. On the other hand, in another embodiment of the present invention, even when the app store server 620 does not receive the begging target recommendation request from the first user terminal 610, the app store server 620 may recommend a begging target for each application, each in-app function or each begging requester in advance and may display, in the application or the in-app function, begging target recommendation information or may automatically display the begging target recommendation information when a specific begging target accesses the app store.

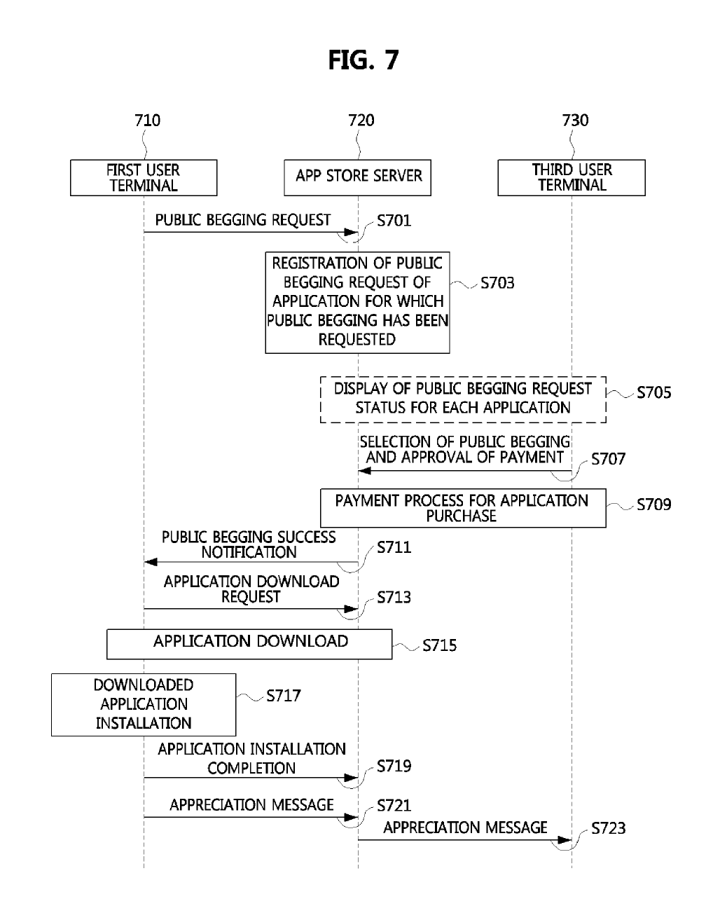

FIG. 7 is a flow diagram illustrating a method of providing an application through public begging in the application providing method according to an embodiment of the present invention.

Referring to FIG. 7, an app store server 720 may provide a user interface (e.g., a request menu or a request button) for a public begging request for each application registered in an app store, and a begging requester may request public begging to an unspecified number of users in order to receive a desired application as a gift using the user interface for a public begging request.

In FIG. 7, a process in which the begging requester who is a user of a first user terminal 710 requests public begging for a predetermined application, and a user of a third user terminal 730 among the unspecified number of users purchases the application for which the begging requester requests public begging in response to the public begging and provides the application as a gift is illustrated.

First, when the begging requester selects a specific application from among a number of applications registered in the app store and then requests public begging for the selected application, the first user terminal 710 transmits a public begging request message to the app store server 720 in response to a user's manipulation (S701). Here, information on the begging requester and the application selected by the begging requester may be contained in the public begging request message.

When the app store server 720 receives the public begging request message from the first user terminal 710, the app store server 720 registers the public begging request for the application for which the public begging has been requested, based on the application information contained in the public begging request message (S703). Here, when a plurality of begging requesters request public begging, the app store server 720 may register the public begging request for the application requested by each begging requester. This process may be performed by the public begging management module 280.

Each time any user requests detailed information of the application registered in the app store, the app store server 720 then displays the detailed information of the application containing public begging request status information (S705). Here, the public begging management module 280 manages a public begging request status for each application and provides management information to the web store module 210, and accordingly, the web store module 210 may display the public begging request status for each application.

In the present invention, the public begging request status for the requests by the begging requesters is displayed for each application as described above, such that an unspecified number of users accessing the app store can confirm the public begging request status for each application.

When a user of a third user terminal 730 selects the public begging target application requested by the user of the first user terminal 710 from among a plurality of applications for which the public begging has been requested and approves the payment, the third user terminal 730 transmits to the app store server 720 a message indicating information for the application selected by the user and payment approval (S707).

The app store server 720 and the third user terminal 730 then perform a payment procedure for purchase of the application selected by the user (S709).

When the payment of the public begging target application is completed, the app store server 720 transmits to the first user terminal 710 a message indicating that the public begging has been successful (S711). Here, a method of downloading a message for which the public begging has been successful may be contained in the public begging success message, which may be transmitted in the form of a push message and displayed.

The first user terminal 710 displays a public begging success message of the specific application in response to the message provided from the app store server 720.

In response to a manipulation of the public begging requester, the first user terminal 710 requests download of the public begging target application to the app store server 720 (S713), and downloads the application from the app store server 720 (S715). Here, the first user terminal 710 may request the download of the public begging target application to the app store server 720 and download the application from the app store server 720 using a browser or an app store client application.

When the download of the public begging target application is completed, the first user terminal 710 installs the downloaded application (S717).

The first user terminal 710 then transmits to the app store server 720 a message indicating that installation of the application has been completed (S719). Here, the app store server 720 may update the public begging request status information in response to the message indicating that installation of the public begging target application has been completed, which has been received from the first user terminal 710.

Further, the first user terminal 710 automatically creates an appreciation message for purchase of the application or an application gift for the user who has approved the public begging or provides a user interface for creation of the appreciation message, and transmits the appreciation message to the app store server 720 when the appreciation message is created (S721). The app store server 720 transmits to the third user terminal 730 the appreciation message received from the first user terminal 710 (S723).

The example of the process in which the begging requester requests public begging for an application and acquires the application is illustrated in FIG. 7, but the public begging is not limited to the acquisition of the application and it is obvious that the public begging may be applied to in-app functions.

Further, the examples in which the respective steps are sequentially performed in the flow diagrams for the method of providing an application according to an embodiment of the present invention are illustrated in FIGS. 4 to 7, but these are intended for convenience of a description. Specific steps of the above steps may be performed prior to the other steps or in parallel with the other steps regardless of the order, or may be repeatedly performed.

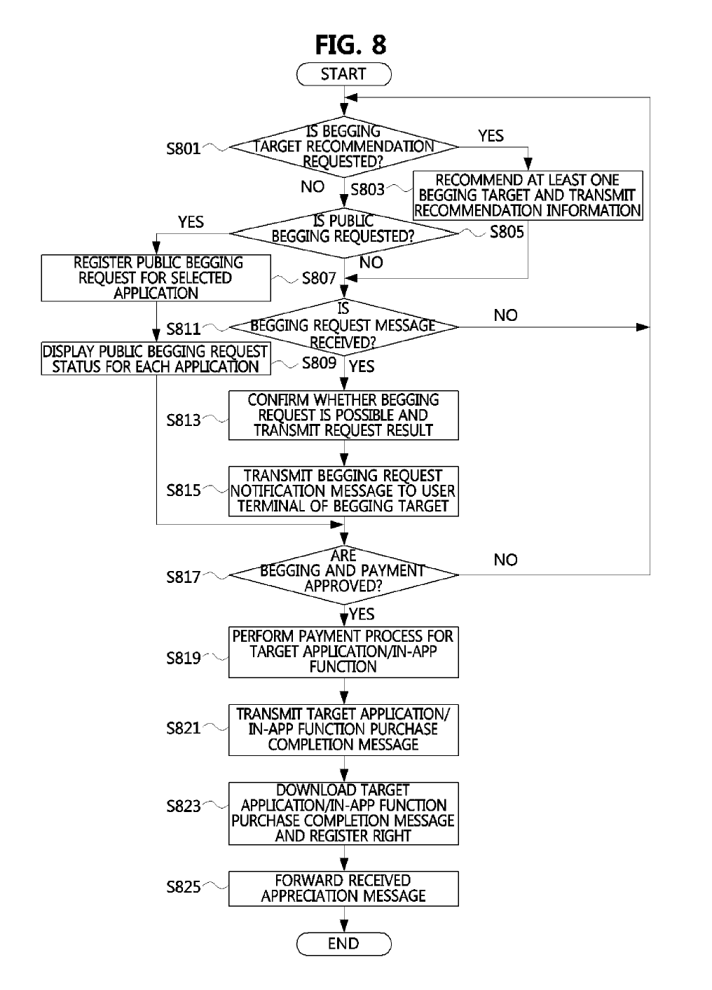

FIG. 8 is a flow diagram illustrating an application providing process in the app store server in the method of providing an application according to an embodiment of the present invention.

Referring to FIG. 8, the app store server determines whether there is a begging target recommendation request for a predetermined application or in-app function from any user terminal (S801).

When there is the begging target recommendation request for a predetermined application from any user terminal, the app store server selects at least one begging target using information such as information of users or user terminals, purchase history, and a relationship between the users according to a previously set criterion, and transmits the at least one selected begging target to the user terminal that has requested the recommendation of the begging target (S803).

When the begging target recommendation request is not received, the app store server determines whether a public begging request for a specific application or in-app function has been received (S805).

Here, when the public begging request for a specific application or in-app function has been received, the app store server registers the public begging request for a public begging request target application or in-app function (S807) and displays public begging request status for each application registered in the app store (S809). The app store server then proceeds to step S817 to perform subsequent steps.

Meanwhile, the app store server monitors whether the begging request message has been received (S811). When the begging request has been received, the app store server confirms whether the begging request is possible and transmits a confirmation result to the user terminal that has transmitted the begging request message (S813). Here, the begging request message may contain information for an application or in-app function as a begging request target, and begging target information or begging requester information. When the begging requester has previously requested begging target recommendation, the begging target may be any one of at least one begging target recommended by the app store server or may be any user selected by the begging requester.

The app store server then transmits a begging request notification message to the user terminal of the begging target (S815). Here, the begging request notification message may be transmitted as a push message.

The app store server monitors whether a message indicating begging and payment approval is received from the user terminal of the begging target (S817). When the message indicating begging and payment approval is received, the app store server performs a payment process for application purchase together with the user terminal of the begging target (S819). Here, the user terminal of the begging target that transmits the message indicating begging and payment approval may be a user terminal of a begging target selected by the begging requester or may be any user terminal having selected a public begging target application.

Meanwhile, when the payment for begging or public begging target application is completed as described above, the app store server transmits a target application purchase completion message to the user terminal of the begging requester (S821).

The app store server then performs a process of downloading the application or registering a right to use the in-app function for the user terminal of the begging requester (S823). Here, when there is an application download request from the user terminal of the begging requester, the app store server may perform a process of downloading the application. When there is a request for approval and/or registration of a right to use a specific in-app function from the user terminal of the begging requester, the app store server may perform a process for approval and/or registration of the right to use the in-app function.

Then, when an appreciation message for purchase of the application or the in-app function is received from the user terminal of the begging requester, the app store server delivers the received appreciation message to the user terminal (S825).

While the example embodiments of the present invention and their advantages have been described in detail, it should be understood that various changes, substitutions and alterations may be made herein without departing from the scope of the invention.

### REFERENCE NUMERALS LIST

| | |
|---|---|
| 101 Tablet PC | 102: PC |
| 103: Smart phone | 104: TV |
| 130: Network | 200 App store server |
| 210: Web store module | |
| 220: User/user terminal profile | |
| management module | |
| 230: Payment management module | 240: Developer support module |
| 250: Application management module | 260: In-app purchase right |
| | management module |
| 270: Squeeze target recommendation | |
| and management module | |
| 280: Public begging management | |
| module | |
| 300: Application providing device | 310: Input/output unit |
| 320: Processing unit | 330: Communication unit |
| 340: Storage unit | 410: First user terminal |
| 420: App store server | 430: Second user terminal |
| 510: First user terminal | 520: app store server |
| 530: Second user terminal | 610 First user terminal |
| 620: App store server | 630: Fourth user terminal |
| 710: First user terminal | 720: App store server |
| 730: Third user terminal | |

What is claimed is:

1. A method of providing an application in an application providing apparatus, the method comprising:
receiving a begging request message for requesting a specific begging target to purchase a specific application or a specific in-app function from a terminal of a begging requester;
transmitting a begging request notification message to a terminal of the specific begging target when the specific begging target approves the begging request; and
when the specific begging target purchases the specific application or the specific in-app function, approving download of the purchased specific application or registering a use right of the purchased specific in-app function.

2. The method according to claim 1, wherein:
the transmitting of the begging request notification message to the terminal of the specific begging target includes:
confirming whether the begging requester and the specific begging target have been registered and whether the specific begging target has approved a begging request; and
when the specific begging target has approved a begging request, transmitting the begging request notification message to the terminal of the specific begging target.

3. The method according to claim 2, wherein:
the transmitting of the begging request notification message to the terminal of the specific begging target further includes:
transmitting a message indicating a begging request result to the terminal of the begging requester based on a result of confirming whether the specific begging target has approved the begging request.

4. The method according to claim 1, wherein:
the transmitting of the begging request notification message to the terminal of the specific begging target includes:
transmitting the begging request notification message to the terminal of the specific begging target as a push message.

5. The method according to claim 1, wherein:
the approving of download of the purchased specific application or the registering of the use right of the purchased specific in-app function includes:
receiving a message indicating begging approval or payment from the terminal of the specific begging target;
performing a payment process for purchase of the specific application or the specific in-app function together with the terminal of the specific begging target; and
transmitting a message indicating that the purchase of the specific application or the specific in-app function has been completed to the begging requester terminal when the payment for the specific application or the specific app function is completed.

6. The method according to claim 5, wherein:
the transmitting of the message indicating that the purchase of the specific application or the specific in-app function has been completed to the begging requester terminal includes:
transmitting information indicating a method of downloading the specific application or a method of registering the specific in-app function, the information being contained in the message indicating that the purchase of the specific application or the specific in-app function has been completed.

7. The method according to claim 1, further comprising:
providing, by the terminal of the begging requester, a user interface for creating an appreciation message, and delivering a received appreciation message to the terminal of the specific begging target when the appreciation message is received from the terminal of the begging requester.

8. The method according to claim 1, further comprising:
providing a user interface for a begging request for an application or an in-app function to the terminal of the begging requester.

9. The method according to claim 1, further comprising:
receiving a message instructing begging target recommendation from the terminal of the begging requester;
selecting at least one begging target from a plurality of users based on a previously set criterion; and
transmitting information on the at least one selected begging target as the begging target recommendation information to the terminal of the begging requester.

10. The method according to claim 9, wherein:
the specific begging target is a begging target selected by the begging requester from among the at least one begging target.

11. The method according to claim 9, wherein:
the selecting of at least one begging target from a plurality of users based on a previously set criterion includes:
selecting the at least one begging target based on begging success probability of each of the plurality of users.

12. A method of providing an application in an application providing apparatus, the method comprising:
receiving a public begging request message for requesting a plurality of unspecified users to purchase a specific application from a terminal of a begging requester;
registering a public begging request for the specific application;
receiving a payment approval message for the specific application from any user terminal;
performing a payment process for purchase of the specific application together with the user terminal; and
transmitting a public begging success notification message for the specific application to the terminal of the begging requester when the payment process is completed.

13. The method according to claim 12, further comprising:
displaying public begging request status for each application.

14. The method according to claim 12, further comprising: after transmitting a public begging success notification message for the specific application to the terminal of the begging requester,
receiving a message for requesting download of the specific application from the terminal of the begging requester; and
approving the download of the specific application.

15. The method according to claim 12, further comprising:
receiving an Installation completion message for the specific application from the terminal of the begging requester; and
providing a user interface enabling the terminal of the begging requester to create an appreciation message, and delivering the received appreciation message to the user terminal when the appreciation message is received from the terminal of the begging requester.

16. An application providing apparatus comprising:
a processing unit configured to receive a begging request message for requesting a begging target to purchase a specific application from a terminal of a begging requester, provide a begging request notification message to a terminal of the begging target, and approve download of a purchased application when the begging target has purchased the application;
a communication unit configured to transmit the begging request notification message to the terminal of the begging target under control of the processing unit and provide the begging request message received from the terminal of the begging requester to the processing unit; and
a storage unit configured to store information on the begging requester and the begging target, and application purchase history information.

17. The application providing apparatus according to claim 16, wherein:
when a message instructing begging target recommendation is received from the terminal of the begging requester, the processing unit selects at least one begging target from a plurality of users based on a previously set criterion and then transmits information on the at least one selected begging target to the terminal of the begging requester via the communication unit.

18. The application providing apparatus according to claim 16, wherein:
the processing unit provides a user interface for a public begging request enabling a begging requester to request a plurality of unspecified users to purchase an application for each application, registers the public begging request for the specific application when a public begging request message for a specific application is received from the terminal of the begging requester, and transmits a public begging success notification message for the specific application to the terminal of the begging requester via the communication unit when any user terminal purchases the specific application.
